(19) United States
(12) Patent Application Publication
(10) Pub. No.: US 2025/0242358 A1
(43) Pub. Date: Jul. 31, 2025

(54) SEPARATOR

(71) Applicant: GEA WESTFALIA SEPARATOR GROUP GMBH, Oelde (DE)

(72) Inventors: Axel BARTSCHER, Oelde (DE); Kathrin QUITER, Drensteinfurt (DE)

(21) Appl. No.: 18/854,122

(22) PCT Filed: Mar. 16, 2023
(86) PCT No.: PCT/EP2023/056733

§ 371 Date: Oct. 4, 2024

(30) Foreign Application Priority Data
Apr. 7, 2022 (DE) 10 2022 108 491.4

(51) Int. Cl. B04B 1/14; B04B 1/08

(52) U.S. Cl. CPC B04B 1/14; B04B 1/08

(57) ABSTRACT

The invention relates to a separator, in particular a self-emptying separator, for centrifugal separation of a flowable product into at least one liquid phase and at least one solid phase, said separator having a rotatable centrifuge drum with a vertical rotation axis, said drum having a separation chamber in which a disc stack is preferably provided, and having solids discharge openings and an emptying mechanism with a single piston valve, which is designed to open and to close the solids discharge openings discontinuously, a control assembly being provided for the emptying mechanism, characterised in that the centrifuge drum has, on its circumference, a first set of solids discharge openings and a second set of solids discharge openings, the first set of solids discharge openings and the second set of solids discharge openings being arranged at two different axial heights on the circumference of the centrifuge drum and thus being vertically distanced from one another, the two sets of solids discharge openings being openable and closable by the single piston valve.

### BACKGROUND AND SUMMARY OF THE INVENTION

Exemplary embodiments of the present invention relate to a self-emptying separator.

In addition to one or more drains for one or more liquid phases, self-emptying separators as defined in this document have an emptying mechanism with a piston valve, which can be moved alternately into an open and a closed position by an actuator, preferably a fluid-actuated actuator, in particular with liquid as the fluid, whereby the piston valve discontinuously opens (open position) and closes (closed position) solids discharge openings in the drum wall for a certain period of time. In the open position, a solid phase is discharged from the centrifuge drum. This is not the case in the closed position.

In such emptying mechanisms with a piston valve, the closing liquid used is injected into a closing chamber-usually below the piston valve. The geometry of this closing chamber is selected so that the liquid pressure created by the rotation of the closing liquid and acting on the piston valve is greater than the liquid pressure of the product to be clarified in the separation chamber above the piston valve. This pressure difference causes the piston valve to rise during operation and closes the emptying openings in the drum or closes them again after the solids have been discharged.

By means of a corresponding valve assembly, such as one or more piston valves, which are in fluid connection with the closing chamber, the closing liquid can be drained from the closing chamber during solids discharge, so that the liquid escapes from the closing chamber-usually below the piston valve-which lowers the pressure acting on the piston valve in the closing chamber, so that the liquid pressure, which the product usually exerts on the piston valve above it, moves the piston valve downwards. This releases or opens the emptying openings in the drum.

An adjustable, variable solids volume that can be emptied from the separator per time unit is desirable.

DE 22 14 487 discloses a separator in which some of the emptying openings are designed as permanently open nozzles, while another part of the set of emptying openings is provided as openings/nozzles that can be opened intermittently.

A separator is known from US 2020/029935 in which the drum is provided with two sets of emptying openings. A piston valve is required to open each set of openings.

U.S. Pat. No. 3,403,849 describes an electromagnetically operated valve for the controlled draining of closing fluid.

However, the emptying devices according to the prior art involve a relatively high design effort and/or offer only an unsatisfactory solution with regard to the adjustability of the time period in which the solids discharge openings are open as well as in the adjustability of the cross-section of the solids discharge openings and thus the variability and adjustability of the solids volume that is emptied from the separator per time unit.

Exemplary embodiments are directed to a separator with an advanced, optimized emptying mechanism.

According to an embodiment, there is provided a separator, in particular a self-emptying separator, for centrifugal separation of a flowable product P into at least one liquid phase L and at least one solid phase S, which has a rotatable centrifuge drum with a vertical rotation axis D, which has a separation chamber, in which a disc stack is preferably provided, and which has solids discharge openings and an emptying mechanism with a single piston valve, which is designed to open and close the solids discharge openings discontinuously, wherein a control assembly is provided for the emptying mechanism, wherein the centrifuge drum has, on its circumference, a first set of solids discharge openings and a second set of solids discharge openings, wherein the first set of solids discharge openings and the second set of solids discharge openings are arranged at two different axial heights on the circumference of the centrifuge drum and thus are vertically spaced from each other, wherein the two sets of solids discharge openings are openable and closable with the single piston valve or are opened or closed, respectively.

This creates a separator with an emptying device for the solid phase, which has a simple design and allows the cross-section of the open solids discharge openings for solids discharge to be easily adjusted. The cross-section of the open solids discharge openings for solids discharge is variable due to the two sets of solids openings, as either one set or both sets of solids openings can be opened by the piston valve. This makes the volume of solids discharged from the separator per unit of time variable and adjustable.

In a particularly preferred embodiment variant of the invention, it is provided that the control assembly for the emptying mechanism comprises a closing chamber for a fluid and comprises a valve assembly having at least one closing chamber valve which communicates with the closing chamber in order to actuate the single piston valve by discharging closing fluid in a switching position.

In a further particularly preferred embodiment variant of the invention, it is provided that the control assembly for the emptying mechanism acts on the valve assembly with the at least one closing chamber valve, which is electrically switchable. This creates a simple possibility, in particular for the closing chamber valve(s), to provide variable adjustability of the solids volume to be emptied. This is because the piston valve can be enabled to move to any intermediate position in order to make the emptying of the solids volume particularly variable.

This means that the closing chamber valve for draining the closing fluid can be opened and closed in a controlled manner. This allows the solids emptying process to be controlled independently of the rest of the centrifuge's separation or clarification process. In particular, it may be decoupled in terms of time.

In a further particularly preferred embodiment of the invention, it may be provided that the piston valve is in a closed position due to a completely filled closing chamber and closes the first set of solids discharge openings and the second set of solids discharge openings.

Furthermore, in a further particularly preferred embodiment variant of the invention, it may be provided that the piston valve is in an open position due to a completely emptied closing chamber and releases and opens the first set of solids discharge openings and the second set of solids discharge openings. In this way, an opening position of the piston valve is easily achieved by proven means, in which a maximum possible solids volume can be emptied per unit of time.

Likewise, in a further preferred embodiment variant of the invention, it may be provided that the piston valve is in a central position due to a partially emptied closing chamber and only releases the first set of solids discharge openings arranged at the top. In this way, a minimum possible emptying of the solids volume per unit of time is simply achieved by design.

Furthermore, in another particularly preferred embodiment variant of the invention, it may be provided that the piston valve can be lowered to the middle position and raised to the middle position. As a result, the middle position of the piston valve can be approached easily and quickly to empty the solids volume.

Furthermore, according to a further embodiment variant of the invention, it may be provided that the piston valve can be positioned in a respective intermediate position in which the cross-section of the solids discharge openings of the first set of solids discharge openings or the cross-section of the solids discharge openings of the second set of solids discharge openings is axially only partially open or axially closed. This achieves a particularly variable adjustability of the dischargeable solids volume during partial discharge.

In a further particularly preferred embodiment variant of the invention, it is provided that the solids discharge openings of the first set of solids discharge openings and the solids discharge openings of the second set of solids discharge openings are placed at an angle offset to one another on the circumference of the centrifuge drum. This results in a structurally simple, strength-optimized arrangement of the two sets of solids discharge openings in the centrifuge drum.

In a further particularly preferred embodiment variant of the invention, it is provided that the number of solids discharge openings of the first set of solids discharge openings and the number of solids discharge openings of the second set of solids discharge openings are different. This simply results in a non-linear correlation between the degree of opening of the piston valve and the solids discharge volume per unit of time.

Furthermore, in a further particularly preferred embodiment variant of the invention, it is provided that the first set of solids discharge openings and the second set of solids discharge openings are each rotationally symmetrical. In this way, a centrifuge drum without imbalance is simply achieved by design. Rotational symmetry is understood here to mean the rotational symmetry around the angular offset of the individual solids openings relative to one another.

Alternatively, in a further preferred embodiment variant of the invention, it may be provided that the combination of the first set of solids discharge openings and the second set of solids discharge openings results in rotational symmetry. This also makes it easy to achieve a centrifuge drum without imbalance.

Furthermore, in a further particularly preferred embodiment variant of the invention, it is provided that an opening cross-section of the solids discharge openings of the first set of solids discharge openings or the solids discharge openings of the second set of solids discharge openings are identical.

This results in a simple linear correlation between the degree of opening of the piston valve and the solids discharge volume per unit of time.

Alternatively, in a further preferred embodiment variant of the invention, it may be provided that the opening cross-sections of the solids discharge openings of the first set of solids discharge openings and the opening cross-sections of the solids discharge openings of the second set of solids discharge openings are dimensioned differently. This creates a non-linear relationship between the position of the piston valve and the volume of solids that can be discharged per unit of time by means of a simple design measure.

Also alternatively, in a further preferred embodiment variant of the invention, it may be provided that the opening cross-sections of the solids discharge openings of the first set of solids discharge openings are of different dimensions and the opening cross-sections of the solids discharge openings of the second set of solids discharge openings are of different dimensions. In a further particularly preferred embodiment variant of the invention, it is provided that the cross-section of the solids discharge openings of the second set of solids discharge openings is smaller than the cross-section of the solids discharge openings of the first set of solids discharge openings. In each case, a non-linear relationship between the position of the piston valve and the volume of solids that can be discharged per unit of time is produced by a simple design measure.

Furthermore, in a further particularly preferred embodiment variant of the invention, it is provided that the respective solids discharge opening is adjoined in each case by a circumferentially closed nozzle-like channel, which in each case extends through a wall of the centrifuge drum and through which the solids S are discharged radially outwards from the centrifuge drum.

Exemplary embodiments are also directed to a method for controlling the solids discharge of a separator, wherein the one single piston valve can be controlled in such a way that it opens the first set of solids discharge openings and/or the second set of solids discharge openings completely axially or partially axially.

In order to increase the precision of this emptying system, it is conceivable to detect the axial position of the piston valve by measurement, transmit it to the control unit, evaluate it there and control the closing fluid valve or the closing chamber valve depending on this evaluation. In this way, the exact positioning of the piston valve is not only controlled but also regulated.

### BRIEF DESCRIPTION OF THE DRAWING FIGURES

In the following, the invention is described in more detail with reference to the drawing by means of an exemplary embodiment. The invention is not limited to this exemplary embodiment, but can also be realized in other ways according to the wording or in other equivalent ways, wherein:

FIG. 1: shows in FIG. 1a) a schematic full section of a separator according to the invention and in FIG. 1b) a sectional enlargement of FIG. 1a;

FIG. 2: shows a sectional enlargement of a schematic full section of an embodiment variant of the separator according to the invention from FIG. 1a;

FIG. 3: shows a schematic full section through a hood of a separator according to the invention;

FIG. 4: shows a schematic full section through a hood of an embodiment variant of a separator according to the invention;

FIG. 5: shows a schematic full section through the housing and through a machine housing of a purifier separator according to the prior art; and

FIG. 6: shows a schematic full section through the drum of a clarifier according to the prior art.

### DETAILED DESCRIPTION

In the following description of the figures, several exemplary embodiments of a separator are described. The individual features of these exemplary embodiments can also be combined with exemplary embodiments not shown and are also suitable in each case as advantageous designs of the objects described in individual or several of the independent and dependent claims.

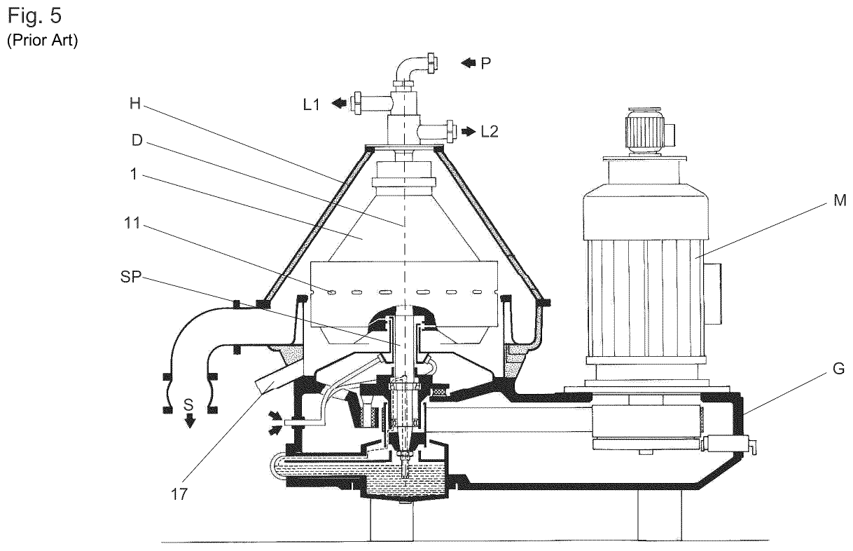

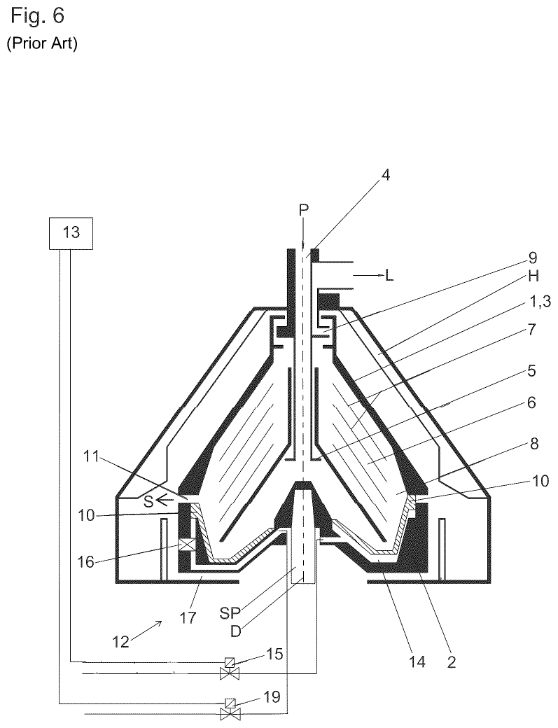

The separator according to the prior art has a rotatable centrifuge drum 1, which can have a vertical rotation axis D as shown in FIGS. 5 and 6. The centrifuge drum 1 can be enclosed by a hood H that does not rotate during operation of the separator. The centrifuge drum 1 is rotated by a drive motor M, which, according to the embodiment in FIG. 5, acts indirectly via a belt drive on a drive spindle SP of the centrifuge drum 1. The drive spindle SP is rotatably mounted in a machine frame G. It carries the centrifuge drum 1, which is placed on a free end of the drive spindle SP. Alternatively, other drive variants can also be realized, for example a direct drive of the centrifuge drum 1, wherein a drive motor acts directly on the drive spindle SP of the centrifuge drum 1.

The centrifuge drum 1 can have a single and/or double conical design (bottom and/or top and in particular inside). The centrifuge drum 1 can have a lower drum part 2 and an upper drum part 3. These drum parts 2, 3 can be connected to each other in various ways, for example with a locking ring (not shown here). The centrifuge drum 1 also has a product feed pipe 4.

The separator is designed for continuous and not just batchwise operation.

A distributor 5 is formed in the centrifuge drum 1 to feed the product from the product feed pipe 4 into a separation chamber 6. The product P is transferred into the rotating system in distributor 5.

The actual centrifugal separation of the product P takes place in the separation chamber 6, which has a disc stack 7 consisting of separation discs. It also has a solids collection chamber 8 radially on the outside, in which the solid phase S separated from the suspension or the flowable product P is collected during the separation and/or clarification process.

The centrifuge drum 1 has at least one liquid outlet for a liquid phase L. The centrifuge drum 1 can also have more than one liquid discharge, as shown in FIG. 5. According to FIG. 6, the liquid discharge is designed as a paring disc 9. The liquid discharge can also be realized in a different way.

FIG. 6 shows an example of a so-called clarifier separator, which is designed to clarify a product P to be processed in a centrifugal field or to separate a solid phase S and a liquid phase L from it. The separator can also be designed as a so-called purifier separator, in which two liquid phases and a solid phase are separated from each other, as shown in FIG. 5.

An emptying mechanism is used to discharge the solid phase S, which has a piston valve 10 for opening and closing solids discharge openings 11. The solids discharge openings 11 present here in a single set can be circumferentially distributed in the area of the largest diameter of the centrifuge drum 1. It is expedient to arrange the solids discharge openings 11 on the circumference of the centrifuge drum 1 in such a way that the solids discharge openings 11 do not lead to an imbalance of the centrifuge drum 1. The piston valve 10 is vertically movable here.

The emptying mechanism further comprises a control assembly 12 associated with the piston valve 10 for controlling its opening and closing movements.

The left half of the centrifuge in FIG. 6 shows the piston valve 10 in a lowered opening position, while the right half of the centrifuge shows the piston valve 10 in a raised closing position.

The control assembly 12 can have a computer-like electronic control device 13 (see FIG. 6) or be connected to it. A higher-level controller of the centrifuge can also be used as this control device 13.

The control assembly 12 also comprises a closing chamber 14 for fluid.

This closing chamber 14 is designed in such a way that the closing movement of the piston valve 10 can be initiated by introducing fluid via a closing fluid valve 15 and in such a way that a closed position of the piston valve 10 can be maintained during rotation at an operating speed for centrifugal processing. The closing fluid valve 15 can be controlled by the electronic control device 13. For the closing movement of the piston valve 10, it is necessary for the closing chamber valve 16 to be closed.

The fluid can be drained from the closing chamber 14 by a valve assembly, which can comprise at least one or more closing chamber valves 16, which are in fluid connection with the closing chamber 14, and thus the solids collection chamber 8 can be emptied through the solids discharge openings 11.

The closing chamber valve 16 is often designed as a centrifugal valve that closes by centrifugal force at the operating speed of the centrifuge drum 1. By introducing an opening fluid via the opening fluid valve 19 into the closing chamber valve 16, the opening movement of the piston valve 10 is initiated and the water is emptied from the closing chamber 14.

What is not optimal about the prior art is that the targeted discharge of only a partial quantity of the fluid from the closing chamber 14 cannot be precisely reproduced, as this depends on the hydraulic pressures above and below the piston valve 10. The cross-section of the solids discharge openings 11 is also not variably adjustable. The invention therefore takes a different approach.

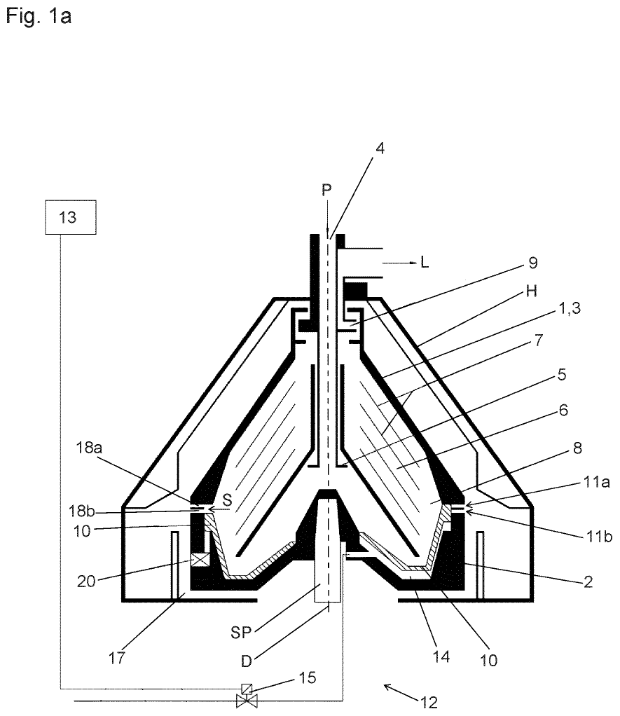

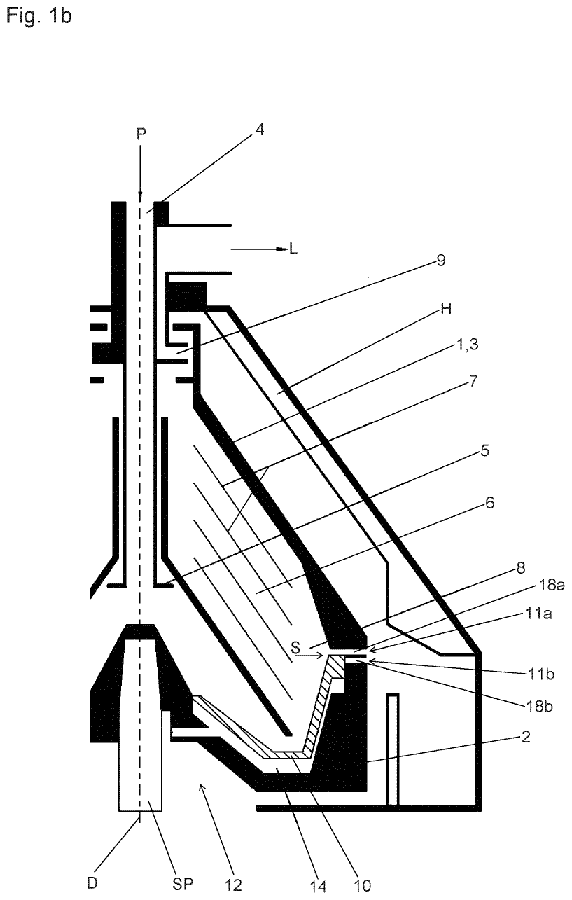

Departing from the prior art, the centrifuge drum 1 of a separator according to the invention has a first set of solids discharge openings 11a and a second set of solids discharge openings 11b on its circumference, as shown in FIGS. 1a, 1b, 2, 3 and 4. Preferably, the first set of solids discharge openings 11a and the second set of solids discharge openings 11b are arranged on the largest radius of the centrifuge drum 1. The first set of solids discharge openings 11a and the second set of solids discharge openings 11b are arranged at two different axial heights on the circumference of the centrifuge drum 1 and are thus vertically spaced apart, as shown in FIGS. 1a, 1b, 2, 3 and 4, and can be opened or closed with a single piston valve 10.

The respective solids discharge opening 11a, 11b is adjoined by a respective channel 18a, 18b, which extends through a respective wall of the centrifuge drum 1 and through which the solids S are discharged radially outwards from the centrifuge drum 1.

When the piston valve 10 is in the closed position (FIG. 1a, right half of the picture) due to a completely filled closing chamber 14, the first set of solids discharge openings 11a and the second set of solids discharge openings 11b are closed by the piston valve 10.

When the piston valve 10 is in the open position (FIG. 1a, left half of image) due to a completely empty closing chamber 14, the first set of solids discharge openings 11a and the second set of solids discharge openings 11b are released and opened by the piston valve.

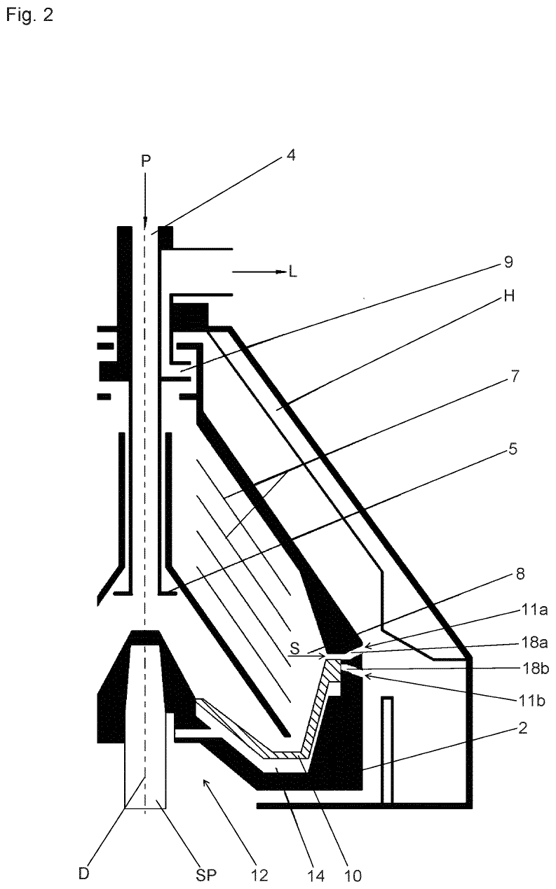

However, if the closing chamber 14 is only partially emptied, the piston valve 10 is in a middle position and only releases the first set of solids discharge openings 11a arranged at the top here (see FIG. 1b and FIG. 2).

In order to be able to position the piston valve 10 to such a “center position”, it is necessary to be able to open and close the closing chamber valve 20 (see FIG. 1a) for a defined period of time in order to drain the closing fluid.

It may therefore be provided that the control assembly 12 for the emptying mechanism acts on the valve assembly with the at least one closing chamber valve 20 and on the single piston valve 10, wherein the closing chamber valve 20 is electrically switchable, i.e., having an electromechanical or piezoelectric operating mechanism. With such a closing chamber valve 20, opening and closing can take place independently of the hydraulic pressures in the centrifuge drum 1.

Accordingly, the at least one closing chamber valve 20 preferably operates as an electric valve, such as a solenoid valve or piezo valve, which can be opened and closed by electrical control pulses from the control device 13. This control pulse could, for example, be sent by radio into the rotating system to a receiver on the valve (not shown). The electrical energy required for this can, for example, be transmitted to the rotating centrifuge drum 1 by means of a system that operates according to the inductive principle. However, an energy storage device, such as a battery, can also be provided in the centrifuge drum 1. The closing chamber valve 20 can also work according to another suitable operating principle.

This allows part of the closing fluid to be emptied from the closing chamber 14 if required. In combination with the product P located above the piston valve 10, which exerts a pressure on the piston valve 10, the piston valve 10 lowers until the pressures below and above the piston valve 10 have equalized and the desired middle position of the piston valve 10 is reached.

In FIG. 1a, FIG. 1b and FIG. 2, the solids discharge opening 11a of the first set of solids discharge openings and the solids discharge opening 11b of the second set of solids discharge openings are shown axially directly above one another, but this is not necessary and is also not advantageous for reasons of strength.

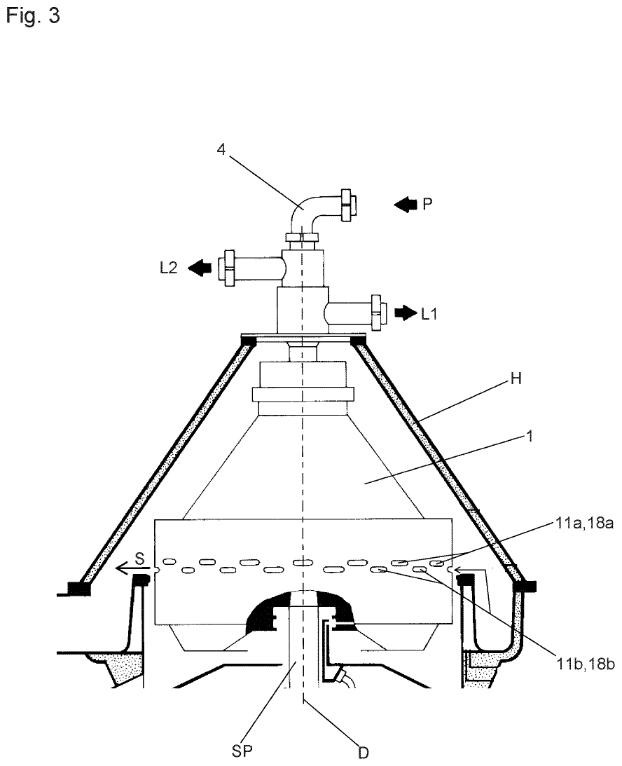

The solids discharge openings 11a of the first set of solids discharge openings and the solids discharge openings 11b of the second set of solids discharge openings can also be positioned at an angle offset to one another on the circumference of the centrifuge drum 1, as shown in FIG. 3.

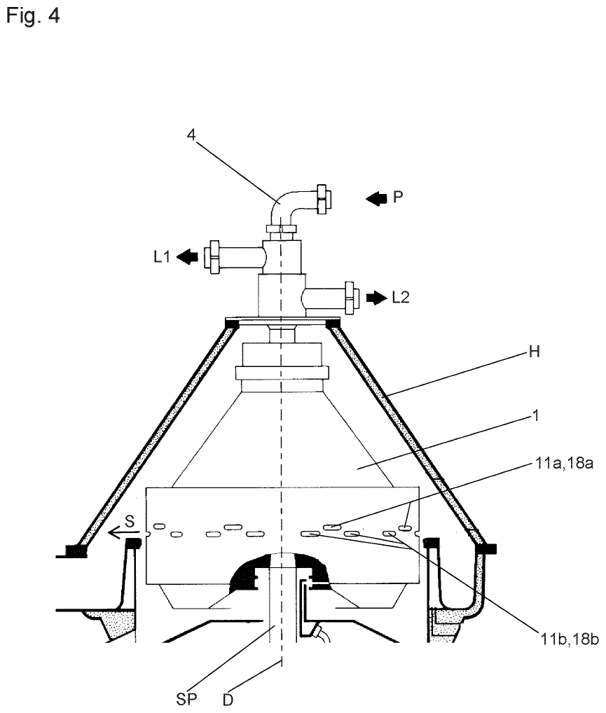

Likewise, the number of solids discharge openings 11a of the first set of solids discharge openings and the number of solids discharge openings 11b of the second set of solids discharge openings can be different, as shown in FIG. 4.

The channels 18a, 18b of the individual solids discharge openings 11a, 11b (which in FIG. 1a and FIG. 1b each show a horizontal course) can also be arranged vertically in a fan shape, so that the inlets of the channels 18a, 18b facing the piston valve 10 have a smaller vertical distance from each other than the outlets of the channels 18a, 18b facing away from the piston valve 10 (see FIG. 2). In each case, two of the channels 18a, b, which lie correspondingly one above the other in the circumferential direction, can thus extend at an angle to each other.

In order to avoid an imbalance of the centrifuge drum 1, it is advantageous if the first set of solids discharge openings 11a and the second set of solids discharge openings 11b are each rotationally symmetrical. However, it is also conceivable that only the combination of the first set of solids discharge openings 11a and the second set of solids discharge openings 11b results in rotational symmetry.

Furthermore, an opening cross-section of the solids discharge openings 11a of the first set of solids discharge openings 11a or the solids discharge openings 11b of the second set of solids discharge openings 11b can be identical. However, it is also conceivable that the opening cross-sections of the solids discharge openings 11a of the first set of solids discharge openings 11a and the opening cross-sections of the solids discharge openings 11b of the second set of solids discharge openings 11b are dimensioned differently. For example, the respective cross-section of the solids discharge openings 11b of the second set of solids discharge openings 11b may be larger than the respective cross-section of the solids discharge openings 11a of the first set of solids discharge openings 11a.

In this way, small quantities of solid S can be emptied from the centrifuge drum 1 per unit of time when the piston valve 10 is in the middle position, while significantly larger quantities of solid S can be emptied from the centrifuge drum 1 per unit of time when the piston valve 10 is fully lowered. In this way, the emptying quantity per unit of time is not linear to the stroke of the piston valve 10.

It is also conceivable that the sum of the opening cross-sections of the solids discharge openings 11a of the first set of solids discharge openings and the sum of the opening cross-sections of the solids discharge openings 11b of the second set of solids discharge openings are dimensioned differently.

The cross-section of the respective solids discharge openings 11a, 11b can be circular, elongated or slot-shaped, oval or elliptical, triangular, rectangular or polygonal.

The open piston valve 10 only rises back to the closed position when closing fluid is again fed into the closing chamber 14 via the closing fluid valve 15. Similar to lowering the piston valve 10 to the middle position, it is also possible to raise the piston valve 10 to the middle position, as the stroke of the piston valve 10 depends on the amount of closing fluid introduced, the density of the closing fluid and the pressure in the closing chamber 14 caused by the centrifugal force.

Alternatively, or additionally, it may also be provided that the piston valve 10 can also be positioned in a respective intermediate position in which the respective cross-section of the solids discharge openings 11a of the first set of solids discharge openings 11a or the respective cross-section of the solids discharge openings 11b of the second set of solids discharge openings 11b is only partially open or closed. The term “partially” means that the piston valve 10 opens the first set of solids discharge openings 11a or the second set of solids discharge openings 11b, e.g. halfway, i.e. not completely.

Precise dosing of the closing fluid quantity can be easily realized with the closing fluid valve 15 and the control device 13.

To increase the precision of this emptying system, it is conceivable to detect the axial position of the piston valve 10 by measurement, transmit it to the control unit 13, evaluate it there and actuate the closing fluid valve 15 or the closing chamber valve 20 depending on this evaluation. In this way, the exact positioning of the piston valve is not only controlled but also regulated.

With the separator described, both the opening time of the solids discharge openings 11a, 11b and the opening cross-section (sum of the cross-sections of the solids discharge openings 11a, 11b released by the piston valve 10) can therefore be adjusted.

### LIST OF REFERENCE SIGNS

1 Centrifuge drum
2 Lower drum part
3 Upper drum part
4 Product feed pipe
5 Distributor
6 Separation chamber
7 Disc stack
8 Solids collection chamber
9 Paring disc
10 Piston valve
11, 11a, 11b Solids discharge opening
12 Control assembly
13 Control device
14 Closing chamber
15 Closing fluid valve
16 Closing chamber valve
17 Drainage channel
18a, 18b Channel
19 Opening fluid valve
20 Closing chamber valve
D Rotation axis
S Solid
L Liquid phase
P Product
M Drive motor
SP Drive spindle
G Machine frame
H Hood

1-22. (canceled)

23. A separator configured to centrifugally separate a flowable product into at least one liquid phase and at least one solid phase, the separator comprising:
a rotatable centrifuge drum with a vertical rotation axis;
a separation chamber;
solids discharge openings;
an emptying mechanism with a single piston valve, wherein the emptying mechanism is configured to open and close the solids discharge openings discontinuously; and
a control assembly configured to control the emptying mechanism,
wherein a first set of solids discharge openings and a second set of solids discharge openings are arranged on a circumference of the centrifuge drum,
wherein the first set of solids discharge openings and the second set of solids discharge openings are arranged at two different axial heights on the circumference of the centrifuge drum and are vertically spaced from each other, and
wherein the first and second sets of solids discharge openings are openable and closable with the single piston valve.

24. The separator of claim 23, wherein the control assembly comprises:
a closing chamber for a fluid; and
a valve assembly having at least one closing chamber valve that communicates with the closing chamber to actuate the single piston valve by discharging closing fluid.

25. The separator of claim 24, wherein the control assembly is configured to act on the valve assembly with the closing chamber valve, which has an electromechanical or piezoelectric operating mechanism.

26. The separator 24, wherein the single piston valve is configured so that the single piston valve is in a closed position due to the closing chamber being completely filled and in the closed position of the single piston valve, the signal piston valve closes the first set of solids discharge openings and the second set of solids discharge openings.

27. The separator of claim 26, wherein the single piston valve is configured so that the single piston valve is in an open position due to the closing chamber being completely emptied and the single piston valve releases and opens the first set of solids discharge openings and the second set of solids discharge openings.

28. The separator of claim 27, wherein the single piston valve is movable into a central position so that the single piston valve only releases the first set of solids discharge openings.

29. The separator of claim 27, wherein the single piston valve is positionable in a respective intermediate position in which a cross-section of solids discharge openings of the first set of solids discharge openings or a cross-section of solids discharge openings of the second set of solids discharge openings is only partially open axially.

30. The separator of claim 23, wherein the centrifuge drum has a single or double conical configuration.

31. The Separator of claim 30, wherein the first set of solids discharge openings and the second set of solids discharge openings are arranged on a largest radius of the single or double conical centrifuge drum.

32. The separator of claim 23, wherein solids discharge openings of the first set of solids discharge openings and solids discharge openings of the second set of solids discharge openings are arranged axially directly one above the other.

33. The separator of claim 23, wherein solids discharge openings of the first set of solids discharge openings and solids discharge openings of the second set of solids discharge openings are placed at an angle offset to one another in a circumferential direction on a circumference of the centrifuge drum.

34. The separator of claim 23, wherein a number of solids discharge openings of the first set of solids discharge openings and a number of solids discharge openings of the second set of solids discharge openings are different.

35. The separator of claim 23, wherein the first set of solids discharge openings and the second set of solids discharge openings are each rotationally symmetrical.

36. The separator of claim 23, wherein an opening cross-section of solids discharge openings of the first set of solids discharge openings are identically dimensioned or an opening cross-section of solids discharge openings of the second set of solids discharge openings are identically dimensioned.

37. The separator of claim 23, wherein opening cross-sections of solids discharge openings of the first set of solids discharge openings and opening cross-sections of solids discharge openings of the second set of solids discharge openings are each dimensioned differently.

38. The separator of claim 23, wherein a sum of opening cross-sections of solids discharge openings of the first set of solids discharge openings and a sum of opening cross-sections of solids discharge openings of the second set of solids discharge openings are each dimensioned differently from one another.

39. The separator of claim 23, wherein a cross-section of a respective solids discharge opening of the second set of solids discharge openings is smaller than a cross-section of a respective solids discharge opening of the first set of solids discharge openings.

40. The separator of claim 23, wherein a cross-section of solids discharge openings of the first or second set of solids discharge openings is circular, slot-shaped, oval, elliptical, triangular, rectangular, or polygonal.

41. The separator of claim 23, wherein a respective solids discharge opening of the first and second solids discharge openings is adjoined by a respective channel extending through a respective wall of the centrifuge drum and through which respective solids are dischargeable radially outwards from the centrifuge drum.

42. The separator of claim 41, wherein respective channels of individual solids discharge openings of the first and second set of solids discharge openings each have a horizontal course.

43. The separator of claim 42, wherein the respective channels of the individual solids discharge openings of the first and second set of solids discharge openings are arranged in a fan shape, so that a inlets of each respective channel facing the piston valve have a smaller vertical distance from one another than outlets of the respective channels facing away from the single piston valve.

44. A method for controlling a separator configured to centrifugally separate a flowable product into at least one liquid phase and at least one solid phase, the separator comprising a rotatable centrifuge drum with a vertical rotation axis; a separation chamber; solids discharge openings; an emptying mechanism with a single piston valve, wherein the emptying mechanism is configured to open and close the solids discharge openings discontinuously; and a control assembly configured to control the emptying mechanism, wherein a first set of solids discharge openings and a second set of solids discharge openings are arranged on a circumference of the centrifuge drum, wherein the first set of solids discharge openings and the second set of solids discharge openings are arranged at two different axial heights on the circumference of the centrifuge drum and are vertically spaced from each other, and wherein the first and second sets of solids discharge openings are openable and closable with the single piston valve, the method comprising:
actuating the single piston valve in such a way that the single piston valve opens or closes the first set of solids discharge openings or the second set of solids discharge openings completely axially or partially axially.
